(19) United States
(12) Patent Application Publication
(10) Pub. No.: US 2022/0288886 A1
(43) Pub. Date: Sep. 15, 2022

(54) DISPLAY DEVICE AND METHOD FOR MANUFACTURING SAME

(71) Applicants: Chengdu BOE Optoelectronics Technology Co., Ltd., Chengdu (CN); BOE Technology Group Co., Ltd., Beijing (CN)

(72) Inventors: Shaopeng LI, Beijing (CN); Junhao AI, Beijing (CN); Tianjun DENG, Beijing (CN); Rongkun FAN, Beijing (CN); Weiben ZHANG, Beijing (CN); Cheng ZHANG, Beijing (CN); Xinfeng ZHOU, Beijing (CN); Wenze LI, Beijing (CN); Xiaolong TANG, Beijing (CN); Fei ZENG, Beijing (CN)

(21) Appl. No.: 17/665,792

(22) Filed: Feb. 7, 2022

(30) Foreign Application Priority Data
Mar. 15, 2021 (CN) 202110276896.6

(51) Int. Cl. B32B 3/30; B32B 3/26; B32B 25/04; B32B 37/16

(52) U.S. Cl. CPC B32B 3/30; B32B 3/266; B32B 25/042; B32B 37/16; B32B 2457/20

(57) ABSTRACT

Disclosed is a display device. The display device includes a flexible display panel, a back film, and a support layer; the flexible display panel includes a bending portion, a first connecting portion, and a second connecting portion; the bending portion is disposed between the first connecting portion and the second connecting portion, the first connecting portion and the second connecting portion being oppositely disposed; the back film is attached to the back of the flexible display panel and includes a first sub-back film corresponding to the first connecting portion and a second sub-back film corresponding to the second connecting portion; the support layer is disposed between the first sub-back film and the second sub-back film, and is connected to the first sub-back film and the second sub-back film; and a portion of the support layer extends into at least one of the first sub-back film and the second sub-back film.

### CROSS-REFERENCE TO RELATED APPLICATION

This application claims priority to Chinese Patent Application No. 202110276896.6, filed on Mar. 15, 2021 and entitled “DISPLAT DEVICE AND METHOD FOR MANUFACTURING SAME,” the disclosure of which is incorporated herein by reference in its entirety.

### TECHNICAL FIELD

The present disclosure relates to the field of display devices and manufacturing technologies thereof, and in particular relates to a display device and a method for manufacturing the same.

### BACKGROUND

A flexible display panel includes a display region and a non-display region. The display region includes a plurality of pixel units forming a pixel array and is a region for displaying content; the non-display region is a region incapable of displaying and is often disposed on the periphery of the display region. The non-display region includes a bonding region (a pad region), wherein a signal line led out from the display region extends to the pad region, and is bonded to a control chip in the pad region.

### SUMMARY

In view of above, embodiments of the present disclosure are intended to provide a display device and a method for manufacturing the same.

According to a first aspect, the embodiments of the present disclosure provide a display device. The display device includes a flexible display panel, a back film, and a support layer; wherein

the flexible display panel includes a bending portion, a first connecting portion, and a second connecting portion; wherein the bending portion is disposed between the first connecting portion and the second connecting portion, and the first connecting portion and the second connecting portion are oppositely disposed;

the back film is attached to the back of the flexible display panel, and includes a first sub-back film corresponding to the first connecting portion and a second sub-back film corresponding to the second connecting portion; and

the support layer is disposed between the first sub-back film and the second sub-back film, and is connected to the first sub-back film and the second sub-back film; and a portion of the support layer extends into at least one of the first sub-back film and the second sub-back film.

In some embodiments, the support layer includes a support layer body and a plurality of extending portions connected to the support layer body, and two opposite sides of the support layer body are respectively connected to the first sub-back film and the second sub-back film; and

the plurality of extending portions are disposed on a surface of the support layer body, and the extending portions are disposed in the back film.

In some embodiments, the extending portion includes an extending body and a protrusion portion which are connected, the extending body protrudes relative to the surface of the support layer body, a gap is defined between the protrusion portion and the support layer body, and at least a portion of an orthographic projection of the protrusion portion on the surface of the support layer body is disposed outside an orthographic projection of the extending body on the surface of the support layer body.

In some embodiments, the protrusion portion is disposed on an end portion, distal from the support layer body, of the extending body.

In some embodiments, a shape of the orthographic projection of the protrusion portion on the surface of the support layer body is one of a circle, an oval, and a polygon.

In some embodiments, the protrusion portion protrudes relative to a side wall of at least a side of the extending body.

In some embodiments, the back film includes a receiving slot and a plurality of extending slots, wherein the plurality of extending slots are disposed on a slot wall of the receiving slot, a portion of the support layer body is disposed in the receiving slot, and the plurality of extending portions are respectively disposed in the plurality of extending slots.

In some embodiments, the extending slots are disposed on both a slot bottom and a side wall of the receiving slot, at least one of the extending portions is disposed on a surface of the support layer body opposite to the slot bottom of the receiving slot, and at least one of the extending portions is disposed on a surface of the support layer body opposite to the side wall of the receiving slot.

In some embodiments, the support layer body includes a support substrate and a support rubber; wherein the support rubber is disposed on two opposite sides of the support substrate, the plurality of extending portions are disposed on a surface of the support rubber, and the support rubber is at least partially disposed in the receiving slot.

In some embodiments the flexible display panel includes a display region and a bonding region, wherein the display region is disposed on the first connecting portion, and the bonding region is disposed on the second connecting portion.

In some embodiments, the plurality of extending portions are at least disposed in the first sub-back film.

In some embodiments, a metal layer is disposed on a side, distal from the flexible display panel, of the first sub-back film, wherein the metal layer is disposed on a side, distal from the bending portion, of the support layer.

In some embodiments, the display device is a quad curved display screen.

In some embodiments, the display device is a flat display device, and the two connecting portions are parallel to each other.

In some embodiments, the first sub-back film includes a first back film substrate and a first back film rubber, the first back film substrate is connected to the flexible display panel by means of the first back film rubber, and the extending portion is disposed in the first back film substrate.

In some embodiments, a material of the first back film substrate is the same as that of the support substrate.

In some embodiments, a material of the first back film rubber is the same as that of the support rubber.

According to a second aspect, the embodiments of the present disclosure provide a method for manufacturing a display device. The method includes:

providing a flexible display panel, wherein the flexible display panel includes a bending portion, a first connecting portion, and a second connecting portion; wherein the bending portion is disposed between the first connecting portion and the second connecting portion, and the first connecting portion and the second connecting portion are oppositely disposed; and

disposing a back film and a support layer between the first connecting portion and the second connecting portion; wherein the back film is attached to a back of the flexible display panel and includes a first sub-back film corresponding to the first connecting portion and a second sub-back film corresponding to the second connecting portion; the support layer is disposed between the first sub-back film and the second sub-back film and is connected to the first sub-back film and the second sub-back film; and a portion of the support layer extends into at least one of the first sub-back film and the second sub-back film.

In some embodiments, disposing the back film and the support layer between the first connecting portion and the second connecting portion includes:

forming the back film on the back of the flexible display panel, the first sub-back film being connected to the first connecting portion, the second sub-back film being connected to the second connecting portion, and at least one extending slot being disposed in a side, distal from the first connecting portion, of the first sub-back film;

disposing the support layer on a side, distal from the first connecting portion, of the first sub-back film, and heating and pressurizing the support layer to cause a portion of the support layer to be filled into the extending slot; and

bending the flexible display panel to cause the second sub-back film to be connected to the support layer.

In some embodiments, disposing the back film and the support layer between the first connecting portion and the second connecting portion includes:

connecting the first sub-back film to the support layer, at least one extending slot being disposed in a surface of the first sub-back film connecting to the support layer, and a portion of the support layer being filled into the extending slot;

connecting a side, distal from the support layer, of the first sub-back film to the first connecting portion, and connecting the second sub-back film to the second connecting portion; and

bending the flexible display panel to cause the second sub-back film to be connected to the support layer.

### BRIEF DESCRIPTION OF THE DRAWINGS

In order to more clearly illustrate the technical solutions in the embodiments of the present disclosure or related technologies, the accompanying drawings that need to be used in the description of the embodiments or related technologies are briefly introduced in the following. Obviously, the drawings in the following description are only one or more embodiments of the present disclosure. For those of ordinary skill in the art, other drawings can be obtained based on these drawings without creative efforts.

FIG. 1 is a schematic structural diagram of a flexible display panel before pad bending according to an embodiment of the present disclosure;

FIG. 2 is a schematic structural diagram of a display device according to an embodiment of the present disclosure;

FIG. 3 is a schematic structural diagram of a support layer and a back film in FIG. 2;

FIG. 4 is a partial enlarged view of a first support rubber in FIG. 3;

FIG. 5 is a schematic structural diagram of another implementation of the support layer and the back film in FIG. 2;

FIG. 6 is a schematic structural diagram of another implementation of the support layer and the back film in FIG. 2;

FIG. 7 is a schematic structural diagram of another display device according to an embodiment of the present disclosure;

FIG. 8 is a flowchart of a method for manufacturing a display device according to an embodiment of the present disclosure;

FIG. 9 is a first schematic structural diagram of a display device in the method illustrated in FIG. 8;

FIG. 10 is a second schematic structural diagram of the display device in the method illustrated in FIG. 8;

FIG. 11 is a third schematic structural diagram of the display device in the method illustrated in FIG. 8;

FIG. 12 is a fourth schematic structural diagram of the display device in the method illustrated in FIG. 8;

FIG. 13 is a fifth schematic structural diagram of the display device in the method illustrated in FIG. 8;

FIG. 14 is a flowchart of a method for manufacturing another display device according to an embodiment of the present disclosure;

FIG. 15 is a first schematic structural diagram of a display device in the method illustrated in FIG. 14;

FIG. 16 is a second schematic structural diagram of the display device in the method illustrated in FIG. 14; and

FIG. 17 is a third schematic structural diagram of the display device in the method illustrated in FIG. 14.

Reference numerals and denotations thereof:

1—flexible display panel, 2—pad region, 3—display region, 4—second sub-back film, 41—second back film substrate, 42—second back film rubber, 5—control chip, 6—FPC, 7—SUS layer, 8—first sub-back film, 81—first back film substrate, 82—first back film rubber, 83—extending slot, 9—support layer, 91—extending portion, 92—first support rubber, 93—support substrate, 94—second support rubber, 96—protrusion portion, 97—extending body, 10—OCA layer, 11—first connecting portion, 12—the bending portion, 13—second connecting portion, 14—curved cover plate, 15— separation slot, 16—back film, 17—support protective film.

### DETAILED DESCRIPTION

In order to obtain a narrower display frame and a higher screen-to-body ratio of a display device, a pad region can be bent to a back side of a display region of a flexible display panel, that is, pad bending. The flexible display panel upon pad bending includes a bending portion and two connecting portions. The display region is disposed in one connecting portion, and the pad region is disposed in the other connecting portion. In the case that the flexible display panel is bent, the two connecting portions are opposite to each other; backs of the two connecting portions, that is, opposite sides of the two connecting portions, are provided with back films; the two connecting portions are also connected by a support layer to support the flexible display panel upon pad bending.

The flexible display panel upon pad bending is prone to peeling between the support layer and the back film under the action of bending stress, especially for display devices with curved edges, such as curved-screen display devices. The two connecting portions on both sides of the bending portion are not planar structures. The connection region is partially arc-shaped. In the arc-shaped region, the support layer and the back film are more likely to peel off due to rebound stress.

On such basis, some embodiments of the present disclosure provide a display device. In the display device, a back film is attached to a back of a flexible display panel and includes a first sub-back film corresponding to a first connecting portion and a second sub-back film corresponding to a second connecting portion. The support layer is disposed between the two connecting portions, and is connected to both the first sub-back film and the second sub-back film. The support layer includes a support rubber connected to the sub-back film. The support rubber includes an extending portion extending into at least one sub-back film. For the support rubber, disposing an extending portion extending into the sub-back film can increase the active area of the support rubber and the sub-back film, thereby increasing the interaction force between the support rubber and the sub-back film, such that a peeling phenomenon of the support layer and the back film is improved.

In addition, since a portion of the support rubber extends into the sub-back film in the form of an extending portion, it is conducive to reducing a thickness of a product and achieving a thinner and lighter product.

In order to make the purpose, technical solutions, and advantages of the embodiments of the present disclosure clearer, the technical solutions in the embodiments of the present disclosure will be clearly and completely described below with reference to the accompanying drawings in the embodiments of the present disclosure. Obviously, the described embodiments are only exemplarity but not all of the embodiments of the present disclosure. Based on the embodiments in the present disclosure, all other embodiments obtained by those of ordinary skill in the art without creative efforts shall fall within the protection scope of the present disclosure.

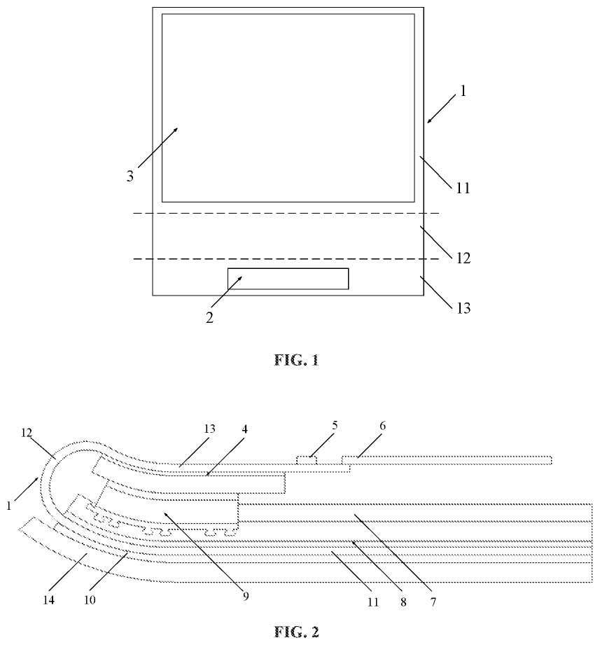

FIG. 1 is a schematic structural diagram of a flexible display panel before pad bending according to an embodiment of the present disclosure, and FIG. 2 is a schematic structural diagram of a display device according to an embodiment of the present disclosure. As illustrated in FIGS. 1 and 2, the display device according to an embodiment of the present disclosure includes a flexible display panel 1, a back film, a support layer 9, a control chip 5, and a flexible printed circuit (FPC) 6.

The flexible display panel 1 includes a display region 3 and a non-display region. The display region 3 is a region capable of displaying content and includes a plurality of pixel units forming a pixel array. The non-display region is a region incapable of displaying content and is often disposed on the periphery region of the display region 3. The non-display region includes a bonding region (a pad region 2, which is also referred to as a crimping region, a terminal region, a pad region, or a liner region). A signal line led from the display region 3 extends to the pad region 2 in which a pin corresponding to the signal line and the control chip 5 bonded to the pin are disposed. The FPC 6 is bonded to control chip 5 disposed in the pad region 2.

The flexible display panel 1 is a plate-like structure that can be bent. In a thickness direction of the flexible display panel 1, a side of the flexible display panel 1 is a display side, which is the side where the display region 3 is disposed, and the other side is a non-display side, which is also called a back side.

A back film is attached to a back of the flexible display panel 1 and is configured to protect and support the flexible display panel 1. The back film includes a back film substrate and a back film rubber. The back film rubber is disposed on a side, proximal to the flexible display panel 1, of the back film substrate, and the back film substrate is connected to the flexible display panel 1 by means of the back film rubber. The back film substrate may be a film layer structure made of metal materials or polymer materials. Taking polymer materials as an example, the material of the back film substrate can be at least one of polyethylene terephthalate (PET), polyimide (PI), and cyclo olefin polymer (COP).

The back film rubber adhesively connects the back film substrate to the flexible display panel 1, and may be at least one of a pressure sensitive adhesive (PSA), an optically clear adhesive (OCA), and a double-sided adhesive.

In order to obtain a narrower display frame and a higher screen-to-body ratio, the display device can bend the pad region 2 to the back of the display region 3, namely pad bending. Referring to FIGS. 1 and 2, in the display device upon pad bending, the flexible display panel 1 includes a bending portion 12 and two connecting portions, and the two connecting portions include a first connecting portion 11 and a second connecting portion 13. The first connecting portion 11 and the second connecting portion 13 are disposed on two ends of the bending portion 12. Under a bending state, the bending portion 12 is disposed between the first connecting portion 11 and the second connecting portion 13, and the first connecting portion 11 and the second connecting portion 13 are oppositely disposed.

The display region 3 is disposed on one of the two connecting portions, and the pad region 2 is disposed on the other of the two connecting portions. As an example, in some embodiments of the present disclosure, the display region 3 is disposed on the first connecting portion 11, the pad region 2 is disposed on the second connecting portion 13, and the control chip 5 and the FPC6 are disposed on the second connecting portion 13.

The display device also includes a curved cover plate 14. The curved cover plate 14 is attached to a side, distal from the second connecting portion 13, of the first connecting portion 11 through Optically Clear Adhesive (OCA) layer 10. In other words, the curved cover plate 14 is attached to the outside of the display region 3 of the flexible display panel 1 to protect the flexible display panel 1.

In some embodiments, the display device is a flat display device, that is, the first connecting portion 11 and the second connecting portion 13 are flat structures parallel to each other.

In some embodiments, the display device is a curved display device, such as a hyperboloid display device or a four-curved display device, and the first connecting portion 11 and the second connecting portion 13 are curved toward a same side. For example, in some embodiments illustrated in FIG. 2, a part of the first connecting portion 11 proximal to the bending portion 12 and a part of the second connecting portion 13 proximal to the bending portion 12 are both bent to a side going away from the display region 3. The bending of the first connecting portion 11 and the second connecting portion 13 makes the rebound stress generated during pad bending more likely to cause peeling problems between the support layer and the back film.

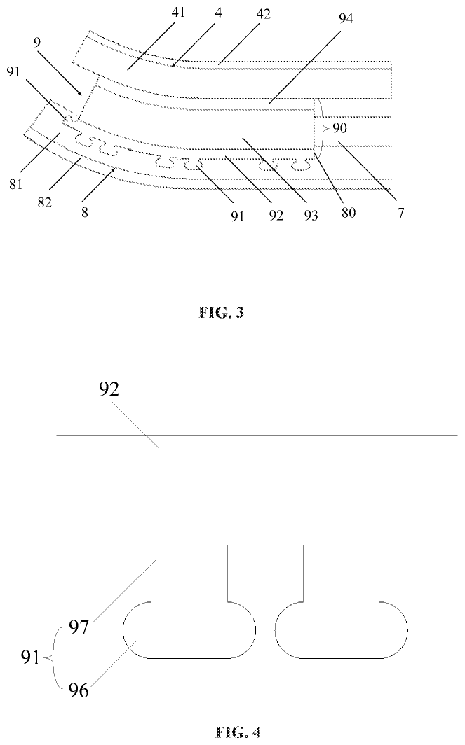

FIG. 3 is a schematic structural diagram of a support layer and a back film in FIG. 2. Referring to FIGS. 2 and 3, the back film is disposed on the back of the flexible display panel 1, and the back film includes two sub-back films. The two sub-back films include a first sub-back film 8 and a second sub-back film 4. The first sub-back film 8 is a portion of the back film corresponding to the first connecting portion 11, and the second sub-back film 4 is a portion of the back film corresponding to the second connecting portion 13.

During pad bending, sometimes a portion of the back film corresponding to the bending portion 12 is removed. For example, in some embodiments illustrated in FIGS. 2 and 3, the portion of the back film corresponding to the bending portion 12 is removed, and the first sub-back film 8 and the second sub-back film 4 are two separate portions in the back film. In addition, in some possible embodiments, sometimes the portion of the back film corresponding to the bending portion 12 is retained, and the first sub-back film 8 and the second sub-back film 4 are two spaced portions of the back film.

The first sub-back film 8 includes a first back film substrate 81 and a first back film rubber 82. The first back film substrate 81 is connected to the flexible display panel 1 by means of the first back film rubber 82. The second sub-back film 4 includes a second back film substrate 41 and a second back film rubber 42, and the second back film substrate 41 is connected to the flexible display panel 1 by means of the second back film rubber 42.

A support layer 9 is disposed between the first sub-back film 8 and the second sub-back film 4, and is connected to the first sub-back film 8 and the second sub-back film 4. A portion of the support layer 9 extends into the inside of at least one of the first sub-back film 8 and the second sub-back film 4.

The support layer 9 is disposed between the first sub-back film 8 and the second sub-back film 4, and is used to connect and support the first sub-back film 8 and the second sub-back film 4. The support layer 9 includes a support layer body 90 and a plurality of extending portions 91 connected to the support layer body 90. Opposite sides of the support layer body 90 are connected to the first sub-back film 8 and the second sub-back film 4 respectively. The plurality of extending portions 91 are disposed on a surface of the support layer body 90 and in the back film.

The support layer body 90 includes a support substrate 93 and a support rubber. The support rubber is disposed on opposite sides of the support substrate 93, and the support rubber includes a first support rubber 92 and a second support rubber 94. The support substrate 93 is connected to the first sub-back film 8 by means of the first support rubber 92, and the support substrate 93 is connected to the second sub-back film 4 by means of the second support rubber 94.

The support substrate 93 may be made of metal materials or polymer materials, usually the same material as the back film substrate, which will not be repeated herein. The first support rubber 92 and the second support rubber 94 are the rubbers for connecting the support substrate 93 and the back film, and usually the same material as the back film rubber is selected. In another possible embodiment, the support layer 9 is a foam (polyurethane foam glue) adhesive layer.

FIG. 4 is a partial enlarged view of the first support rubber in FIG. 3. Referring to FIGS. 3 and 4, in some embodiments of the present disclosure, the extending portion 91 protrudes relative to the first support rubber 92, and is disposed in the first back film substrate 81.

The extending portion 91 includes an extending body 97 and a protrusion portion 96 which are connected. The extending body 97 protrudes relative to the surface of support layer body 90, that is, protruding from the support rubber. A gap is defined between the protrusion portion 96 and the support layer body 90. An orthographic projection of the protrusion portion 96 on the surface of the support layer body 90 is at least partially disposed outside an orthographic projection of the extending body 97 on the surface of the support layer body 90.

One end of the extending body 97 is connected to the support layer body 90, and the other end is away from the support layer body 90. A side wall of the extending body 97 is an outer surface between two end surfaces of the extending body 97. The protrusion portion 96 protrudes relative to a side wall of at least one side of the extending body 97, such that an orthographic projection of the protrusion portion 96 on the surface of the support layer body 90 is at least partially disposed outside an orthographic projection of the extending body 97 on the surface of the support layer body 90. The protrusion portion 96 may avoid the extending portion 91 from peeling from the back film.

The orthographic projection of the protrusion portion 96 on the surface of the support layer body 90 is one of a circle, an oval, and a polygon.

In some embodiments of the present disclosure, the protrusion portion 96 is disposed on an end portion, distal from the first support rubber 92, of the extending body 97. An orthographic projection of the protrusion portion 96 on the surface of the first support rubber 92 is a circle.

The back film is provided with a receiving slot to receive a partial region of the support layer body 90. Referring to FIGS. 2 and 3, a receiving slot 80 is disposed in a side of the first back film substrate 81 towards the first support rubber 92, and the first support rubber 92 is disposed in the receiving slot 80. The receiving slot 80 is a square slot corresponding to the first support rubber 92, a slot wall of the receiving slot 80 is provided with an extending slot 83 that matches with the extending portion 91, and the plurality of extending portions 91 are disposed in the plurality of extending slots 83.

In some embodiments, the extending slots 83 are provided on both a slot bottom and side walls of the receiving slot 80. At least one extending portion 91 is disposed on the surface of the support layer body 90 opposite to the slot bottom of the receiving slot 80, and at least one extending portion 91 is disposed on the surface of the support layer body 90 opposite to the side wall of the receiving slot 80.

In some embodiments, the first support rubber 92 is provided with the extending portions 91 on an end surface and a side distal from the support substrate 93. According to different disposed positions, the extending portion 91 is divided into a side-surface extending portion and an end-surface extending portion. The side-surface extending portion is disposed on a side, distal from the support substrate 93, of the first support rubber 92, and is disposed in the extending slot 83 on the bottom of the receiving slot 80. A cross section of the side-surface extending portion vertical to the surface of first support rubber 92 is T-shaped.

The end-surface extending portion is disposed on the end surface of the first support rubber 92, that is, the surface of the first support rubber 92 opposite to the side wall of the receiving slot 80. In some embodiments, a cross section of the end-surface extending portion vertical to the end surface of the first support rubber 92 is L-shaped.

The protrusion portion 96 in some embodiments of the present disclosure is not limited to this, and a shape of the protrusion portion 96 may also be a square, a triangle, or any other shape. In addition, a location of the protrusion portion 96 on the extending body 97 is not limited to an end of the extending body 97, and may also be optionally set at a location between the end of the extending body 97 and the support layer body 90.

FIG. 5 is a schematic structural diagram of another implementation of the support layer and the back film in FIG. 2. As illustrated in FIG. 5, a difference between this embodiment and the implementation illustrated in FIG. 3 is that: the protrusion portion 96 of the extending portion 91 is a rectangular protrusion.

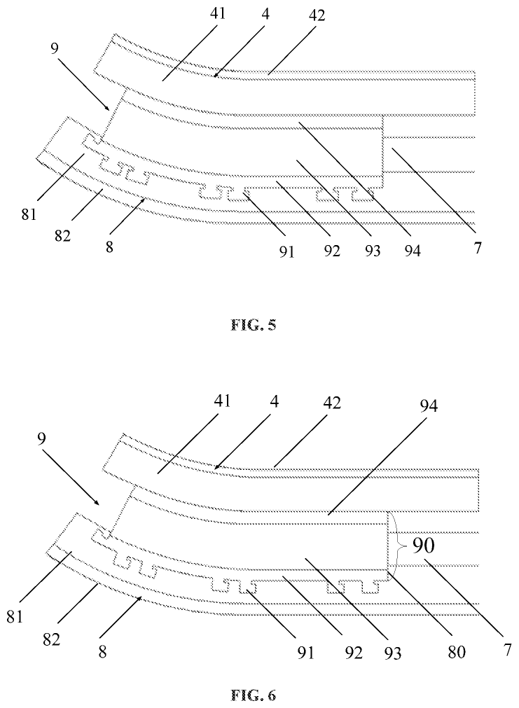

FIG. 6 is a schematic structural diagram of another implementation of the support layer and the back film in FIG. 2. As illustrated in FIG. 6, a difference between this embodiment and the implementation illustrated in FIG. 5 is that: in the side-surface extending portion, the protrusion portion 96 at the end protrudes outward relative to a single side of the extending body 97 to form an L-shaped structure.

In the display device according to some embodiments of the present disclosure, the interaction force between the support layer and the first sub-back film can be effectively improved by setting the protrusion portion and the receiving slot and setting the extending portion (the side-surface extending portion and the end-surface extending portion) at different positions, thereby improving the peeling problem between the support layer and the first sub-back film.

The cooperation of the receiving slot and the support rubber, and the cooperation of the extending portion and the extending slot can reduce a thickness of the stack on the basis of ensuring the reliability of the connection between the back film and the support layer, which is conducive to the realization of thinner and lighter products.

In the above embodiment, since the first connecting portion 11 and the second connecting portion 13 are curved structures, and both are bent to the side going away from the display region 3, there is a possibility of peeling between the first support rubber 92 and the first back film substrate 81, and being a greater possibility of peeling compared with the second support rubber 94 and the second back film substrate 41. Therefore, in this embodiment, only the first support rubber 92 is provided with the extending portion 91 extending into the first back film substrate 81.

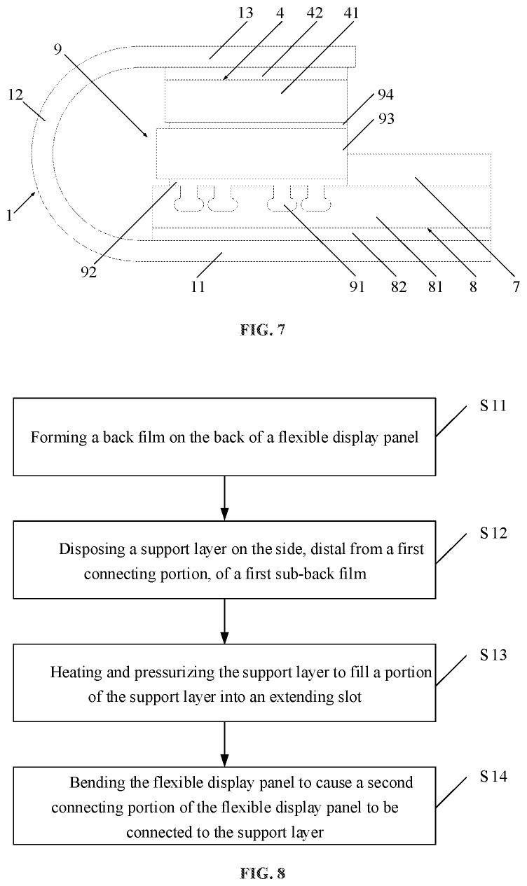

The above only takes the cooperation between the support layer 9 and the first sub-back film 8 as an example, but the embodiments of the present disclosure are not limited to this. The cooperation form between the support layer 9 and the first sub-back film 8 is also applicable to the cooperation between the support layer 9 and the second sub-back film 4. For example, the extending portion 91 may be set corresponding to the second sub-back film 4, and may also be set corresponding to the first sub-back film 8 and the second sub-back film 4. Moreover, a design of the extending portion 91 is not only applied to pad bending of curved display devices, such as the display devices illustrated in FIG. 2, FIG. 3, FIG. 5, and FIG. 6, but also is applied to pad bending of flat display devices, such as the display device illustrated in FIG. 7.

FIG. 7 is a schematic structural diagram of another display device according to an embodiment of the present disclosure. As illustrated in FIG. 7, the first back film substrate 81 is only provided with the extending slot, not the receiving slot. The first support rubber 92 is stacked on a side, distal from the first back film substrate 82, of the first back film substrate 81, the extending portion 91 is only disposed on a side, distal from the support substrate 93, of the first support rubber 92, that is, only the side-surface extending portion but no the end-surface extending portion is disposed.

Referring to FIGS. 2, 3, and 5 to 7, in the display devices according to some embodiments of the present disclosure, a metal layer 7 is provided on a side, distal from the flexible display panel 1, of the first sub-back film 8, and the metal layer 7 is disposed on a side, distal from the bending portion 12, of the support layer 9.

Illustratively, the metal layer 7 is a steel use stainless (SUS) layer, wherein the SUS layer 7 is a film layer structure disposed on a side, distal from the first back film rubber 82, of the first back film substrate 81, and is disposed on the side, distal from the bending portion 12, of the support layer 9.

An embodiment of the present disclosure provides a method for manufacturing a display device, which is applicable to manufacturing the display device in the above embodiments. The method includes the following processes.

In 51, the flexible display panel 1 is provided.

The flexible display panel 1 includes the bending portion 12, the first connecting portion 11, and the second connecting portion 13. The bending portion 12 is disposed between the first connecting portion 11 and the second connecting portion 13 which are oppositely disposed.

In S2, the back film and the support layer 9 are disposed between the first connecting portion 11 and the second connecting portion 13.

The back film is attached on the back of the flexible display panel 1. The back film includes the first sub-back film 8 corresponding to the first connecting portion 11 and the second sub-back film 4 corresponding to the second connecting portion 13. The support layer 9 is disposed between the first sub-back film 8 and the second sub-back film 4, and is connected to the first sub-back film 8 and the second sub-back film 4. A portion of the support layer 9 extends into inside of at least one of the first sub-back film 8 and the second sub-back film 4.

It can be known according to the previous descriptions that the support layer is provided with at least one extending portion extending into the sub-back film, which includes the following cases:

Case A: The extending portion is only disposed on the first support rubber.

Case B: The extending portion is only disposed on the second support rubber.

Case C: One part of the extending portion is disposed on the first support rubber, and the other part of the extending portion is disposed on the second support rubber.

In addition, the back film and the support layer can be supplied separately, that is, the back film is sequentially manufactured on the flexible display panel, and the back film and the support layer may also be supplied together, that is, the back film and the support layer are first manufactured as a whole, and then connected to the flexible display panel.

Referring to FIG. 8, in view of case A, the back film and the support layer are supplied separately. The method includes the following processes.

In S11, the back film on the back of the flexible display panel is formed.

The back film is attached to the back side of the flexible display panel to protect and support the flexible display panel. The back film includes the back film substrate and the back film rubber. The back film rubber is disposed on a side, proximal to the flexible display panel, of the back film substrate, and the back film substrate is connected to the flexible display panel by means of the back film rubber.

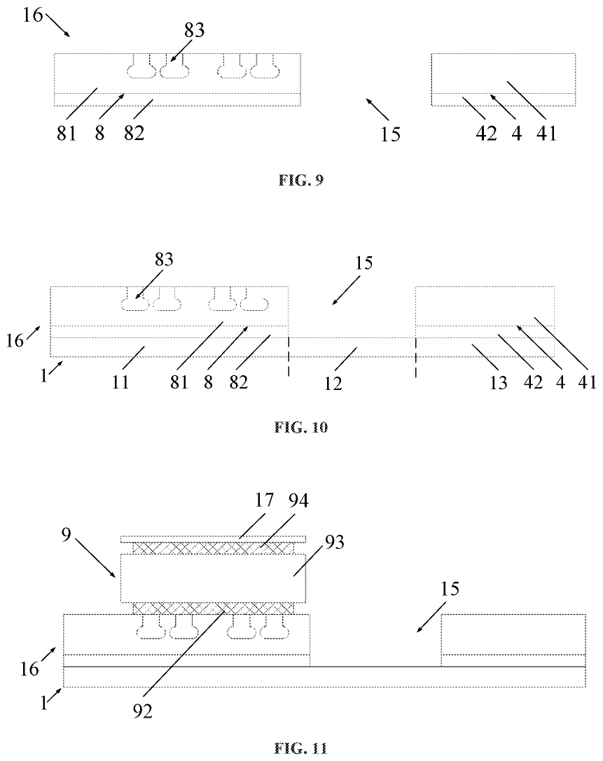

Referring to FIG. 9, corresponding to different positions of the flexible display panel, a back film 16 includes the first sub-back film 8 and the second sub-back film 4. The first sub-back film 8 includes first back film substrate 81 and first back film rubber 82. The second sub-back film 4 includes the second back film substrate 41 and the second back film rubber 42. The first back film rubber 82 is connected to a first connecting portion of the flexible display panel, and the second back film substrate 41 is connected to a second connecting portion of the flexible display panel.

The process of manufacturing the back film 16 generally includes: obtaining a back film substrate, manufacturing the extending slot 83 in a side of the first back film substrate 81, and coating, upon completion of the manufacturing of the extending slot 83, a back film rubber on a side, distal from the extending slot 83, of the back film substrate to form the back film rubber.

The process of manufacturing the back film 16 may include cutting the back film 16 into a size corresponding to the flexible display panel, removing a portion of the back film 16 corresponding to the bending portion. In the case that the portion of the back film 16 corresponding to the bending portion is removed, the remaining space is defined as a separation slot 15, and the back film 16 is divided into the first sub-back film 8 and the second sub-back film 4 by the separation slot 15.

In the case that the back film 16 is formed, the corresponding back film protective film is attached to protect the back film 16. The back film is attached to the back side of the flexible display panel, the first sub-back film 8 is connected to the first connecting portion 11, and the second sub-back film 4 is connected to the second connecting portion 13. At least one extending slot 83 is disposed in a side, distal from the first connecting portion 11, of the first sub-back film 8.

Referring to FIG. 10, a protective film of the back film is removed, and the back film 16 is attached to the back side of the flexible display panel 1 by means of the back film rubber. In the case that the back film 16 and the flexible display panel 1 are attached, the first sub-back film 8 is disposed on the first connecting portion 11, the second sub-back film 4 is disposed on the second connecting portion 13, and the separation slot 15 is disposed on the bending portion 12.

In S12, the support layer is disposed on a side, distal from the first connecting portion, of the first sub-back film.

Referring to FIG. 11, the support layer 9 includes the support substrate 93 and two support rubbers disposed on two sides of the support substrate 93. The two support rubbers are respectively the first support rubber 92 and the second support rubber 94, wherein the support substrate 93 is connected to the first sub-back film 8 by means of the first support rubber 92, and the support substrate 93 is connected to the second sub-back film 4 by means of the second support rubber 94.

In S12, the support layer 9 is disposed at the position of the first back film substrate 81 corresponding to the extending slot 83; the first support rubber 92 is in contact with the first back film substrate 81; the support protective film 17 is disposed on a side, distal from the first support rubber 92, of the second support rubber 94 to prevent the second support rubber 94 from sticking to other structures during the manufacturing process, thereby playing a protective role; and the support protective film 17 is removed in a subsequent process.

In S13, the support layer is heated and pressured to fill a portion of the support layer into the extending slot.

Referring to FIG. 12, the first support rubber 92 may be extruded and filled into the extending slot 83 under heating and pressurizing to form the extending portion 91 corresponding to the extending slot 83.

In S14, the flexible display panel is bent to cause the second connecting portion of the flexible display panel to be connected to the support layer.

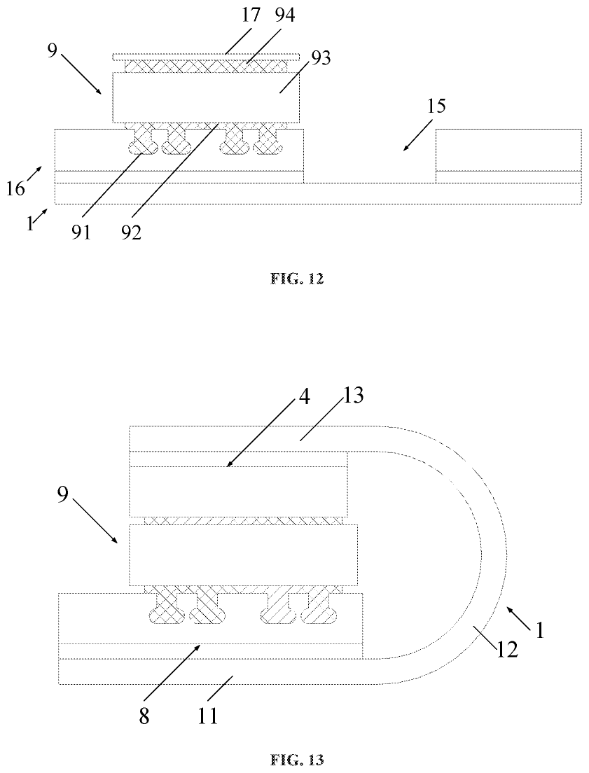

Referring to FIG. 13, the support protective film 17 is removed and the flexible display panel 1 is bent, such that the second sub-back film 4 on the back of the second connecting portion 13 is opposite to the second support rubber 94, and then the second sub-back film 4 and the second support rubber 94 are connected.

In the display device manufactured by S11 to S14, the support layer 9 includes the extending portion 91 extending into the first sub-back film 8. Disposing the extending portion may increase the active area of the support rubber and the sub-back film, thereby increasing the interaction force between the support rubber and the sub-back film and improving the peeling phenomenon of the support layer and the back film.

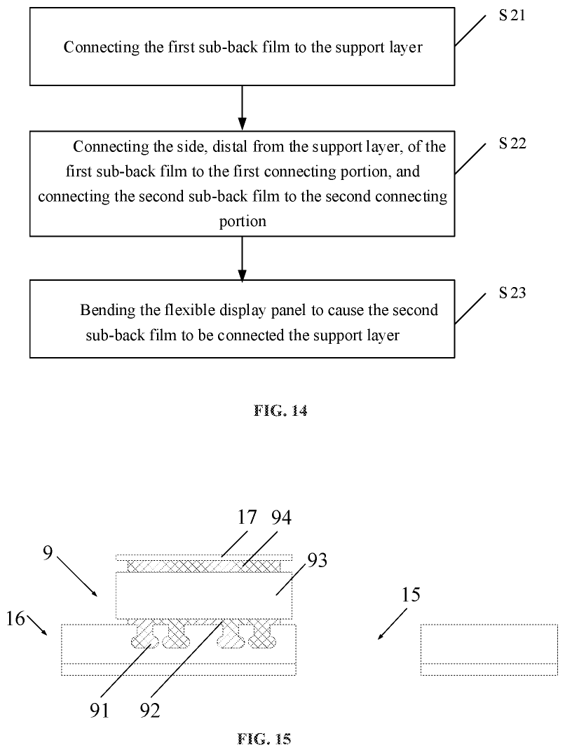

As illustrated in FIG. 14, in view of case A, the back film and the support layer are supplied together. The method includes:

In S21, the first sub-back film and the support layer are connected.

At least one extending slot 83 is disposed on the surface of the first sub-back film 8 connected to the support layer 9, and a portion of the support layer 9 is filled into the extending slot 83.

That is, the first sub-back film 8 and the support layer 9 are manufactured as a whole, and then the whole is connected to the flexible display panel.

In S22, a side, distal from the support layer, of the first sub-back film is connected to the first connecting portion, and the second sub-back film is connected to the second connecting portion.

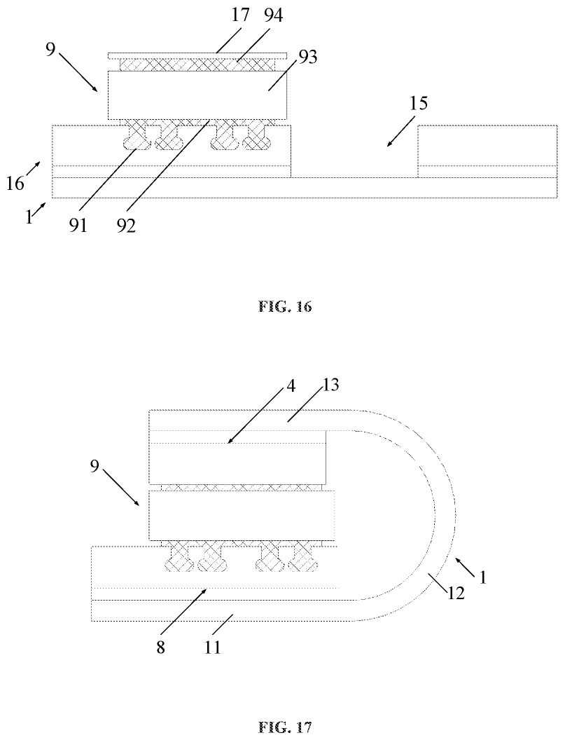

The back film provided with the support layer is attached to the back side of the flexible display panel, and the two sub-back films are respectively connected to the two connecting portions. Referring to FIGS. 15 and 16, the back film 16 and the support layer 9 are supplied together, which means that the two are supplied as an integrated product, corresponding to case A. The extending slot is disposed in a side of first back film substrate 81, the support layer 9 is disposed on the first sub-back film 8, and the extending portion 91 extending into first sub-back film 8 is provided. The support protective film 17 is disposed on a side, distal from the first support rubber 92, of the second support rubber 94 to prevent the second support rubber 94 from sticking to other structures during the manufacturing process, thereby playing a protective role; the support protective film 17 is removed in a subsequent process.

In S23, the flexible display panel is bent to connect the second sub-back film to the support layer.

Referring to FIG. 17, the support protective film 17 is removed and the flexible display panel 1 is bent, such that the second sub-back film 4 on the back of the second connecting portion 13 is opposite to the second support rubber 94, and then the second sub-back film 4 and the second support rubber 94 are connected.

For the above-mentioned case B and case C, the methods and the steps can be adjusted by referring to the above-mentioned manufacturing process, which will not be repeated herein.

Some embodiments of the present disclosure provide an electronic device, including the display device in the above embodiments. The electronic device may be a mobile phone, a tablet, a laptop, a smart TV, a smart speaker with a screen, or the like.

In the description of the embodiments of the present disclosure, it should be noted that the orientation or positional relationship indicated by terms “center,” “upper,” “lower,” “left,” “right,” “vertical,” “horizontal,” “inner,” “outer,” and the like is based on the orientation or positional relationship illustrated in the accompanying drawings, and is only for the convenience of describing the present disclosure and simplifying the description, rather than indicating or implying that the device or element referred to must have a specific orientation, or must be constructed and operated in a specific orientation, which, therefore, cannot be understood as a restriction on the present disclosure. In addition, terms “first,” “second,” and “third” are only used for descriptive purposes, and cannot be understood as indicating or implying relative importance.

In the description of the embodiments of the present disclosure, it should be noted that, unless otherwise clearly specified and limited, the terms “installation,” “connected,” and “connection” should be interpreted in a broad sense; for example, it can be a fixed connection, a detachable connection, or an integral connection; it can be a mechanical connection or an electrical connection; it can be directly connected, or indirectly connected through an intermediate medium, and it can be an internal communication between two components. For those of ordinary skill in the art, the specific meanings of the above terms in the embodiments of the present disclosure can be understood in specific situations.

In addition, the technical features involved in the different implementations of the present disclosure described above can be combined with each other as long as they do not conflict with each other.

The technical solutions of the present disclosure have been described in conjunction with the optional implementations illustrated in the accompanying drawings. However, it is easily understood by those skilled in the art that the protection scope of the present disclosure is obviously not limited to these specific implementations. Without departing from the principle of the present disclosure, those skilled in the art can make equivalent changes or substitutions to the relevant technical features, and the technical solutions after these changes or substitutions will fall within the protection scope of the present disclosure.

What is claimed is:

1. A display device, comprising a flexible display panel, a back film, and a support layer; wherein
the flexible display panel comprises a bending portion, a first connecting portion, and a second connecting portion, wherein the bending portion is disposed between the first connecting portion and the second connecting portion, and the first connecting portion and the second connecting portion are oppositely disposed;
the back film is attached to the back of the flexible display panel, and comprises a first sub-back film corresponding to the first connecting portion and a second sub-back film corresponding to the second connecting portion; and
the support layer is disposed between the first sub-back film and the second sub-back film, and is connected to the first sub-back film and the second sub-back film; and a portion of the support layer extends into at least one of the first sub-back film and the second sub-back film.

2. The display device according to claim 1, wherein the support layer comprises a support layer body and a plurality of extending portions connected to the support layer body, and two opposite sides of the support layer body are respectively connected to the first sub-back film and the second sub-back film; and
the plurality of extending portions are disposed on a surface of the support layer body, and the extending portions are disposed in the back film.

3. The display device according to claim 2, wherein the extending portion comprises an extending body and a protrusion portion which are connected, the extending body protrudes relative to the surface of the support layer body, a gap is defined between the protrusion portion and the support layer body, and at least a portion of an orthographic projection of the protrusion portion on the surface of the support layer body is disposed outside an orthographic projection of the extending body on the surface of the support layer body.

4. The display device according to claim 3, wherein the protrusion portion is disposed on an end portion, distal from the support layer body, of the extending body.

5. The display device according to claim 2, wherein a shape of the orthographic projection of the protrusion portion on the surface of the support layer body is one of a circle, an oval, and a polygon.

6. The display device according to claim 2, wherein the protrusion portion protrudes relative to a side wall of at least a side of the extending body.

7. The display device according to claim 2, wherein the back film comprises a receiving slot and a plurality of extending slots, the plurality of extending slots are disposed on a slot wall of the receiving slot, a portion of the support layer body is disposed in the receiving slot, and the plurality of extending portions are respectively disposed in the plurality of extending slots.

8. The display device according to claim 7, wherein the extending slots are disposed on both a slot bottom and a side wall of the receiving slot, at least one of the extending portions is disposed on a surface of the support layer body opposite to the slot bottom of the receiving slot, and at least one of the extending portions is disposed on a surface of the support layer body opposite to the side wall of the receiving slot.

9. The display device according to claim 7, wherein the support layer body comprises a support substrate and a support rubber; wherein the support rubber is disposed on two opposite sides of the support substrate, the plurality of extending portions are disposed on a surface of the support rubber, and the support rubber is at least partially disposed in the receiving slot.

10. The display device according to claim 9, wherein the flexible display panel comprises a display region and a bonding region, the display region is disposed on the first connecting portion, and the bonding region is disposed on the second connecting portion.

11. The display device according to claim 10, wherein
the plurality of extending portions are at least disposed in the first sub-back film.

12. The display device according to claim 10, wherein a metal layer is disposed on a side, distal from the flexible display panel, of the first sub-back film, and the metal layer is disposed on a side, distal from the bending portion, of the support layer.

13. The display device according to claim 1, wherein the display device is a quad curved display screen.

14. The display device according to claim 1, wherein the display device is a flat display device, and the two connecting portions are parallel to each other.

15. The display device according to claim 11, wherein the first sub-back film comprises a first back film substrate and a first back film rubber, the first back film substrate is connected to the flexible display panel by means of the first back film rubber, and the extending portion is disposed in the first back film substrate.

16. The display device according to claim 15, wherein a material of the first back film substrate is the same as that of the support substrate.

17. The display device according to claim 15, wherein a material of the first back film rubber is the same as that of the support rubber.

18. A method for manufacturing a display device, comprising:
providing a flexible display panel, wherein the flexible display panel comprises a bending portion, a first connecting portion, and a second connecting portion; wherein the bending portion is disposed between the first connecting portion and the second connecting portion, and the first connecting portion and the second connecting portion are oppositely disposed; and
disposing a back film and a support layer between the first connecting portion and the second connecting portion; wherein the back film is attached to a back of the flexible display panel and comprises a first sub-back film corresponding to the first connecting portion and a second sub-back film corresponding to the second connecting portion; the support layer is disposed between the first sub-back film and the second sub-back film and is connected to the first sub-back film and the second sub-back film; and a portion of the support layer extends into at least one of the first sub-back film and the second sub-back film.

19. The method according to claim 18, wherein disposing the back film and the support layer between the first connecting portion and the second connecting portion comprises:
forming the back film on the back of the flexible display panel, the first sub-back film being connected to the first connecting portion, the second sub-back film being connected to the second connecting portion, and at least one extending slot being disposed in a side, distal from the first connecting portion, of the first sub-back film;
disposing the support layer on a side, distal from the first connecting portion, of the first sub-back film, and heating and pressurizing the support layer to cause a portion of the support layer to be filled into the extending slot; and
bending the flexible display panel to cause the second sub-back film to be connected to the support layer.

20. The method according to claim 18, wherein disposing the back film and the support layer between the first connecting portion and the second connecting portion comprises:
connecting the first sub-back film to the support layer, at least one extending slot being disposed in a surface of the first sub-back film connecting to the support layer, and a portion of the support layer being filled into the extending slot;
connecting a side, distal from the support layer, of the first sub-back film to the first connecting portion, and connecting the second sub-back film to the second connecting portion; and
bending the flexible display panel to cause the second sub-back film to be connected to the support layer.
